(19) United States
(12) Patent Application Publication
(10) Pub. No.: US 2024/0397574 A1
(43) Pub. Date: Nov. 28, 2024

(54) NETWORK ENHANCEMENT FOR REDUCING INTERFACE TRAFFIC AND STORAGE OF SESSION MANAGEMENT FUNCTION

(71) Applicant: Cisco Technology, Inc., San Jose, CA (US)

(72) Inventors: Mukesh Yadav, Fremont, CA (US); Arvind Chandrakar, Bangalore (IN)

(21) Appl. No.: 18/324,379

(22) Filed: May 26, 2023

(51) Int. Cl. H04W 76/25; H04M 15/00

(52) U.S. Cl. CPC H04W 76/25; H04M 15/66

(57) ABSTRACT

Method for reducing interface traffic and memory of a session management function (SMF) establishes an exchange of preservation between the SMF and a policy control function (PCF) via an interface for a first session by a first subscriber in a wireless network. The method also includes receiving, by the SMF from the PCF, the preservation including definitions of common data and a preserve indication for the definitions of the common data. The definitions of the common data are used for a plurality of sessions following the first session by a plurality of subscribers. The method also includes storing, by the SMF, the definitions of common data; establishing an exchange of preservation between the SMF and the PCF for one of the plurality of sessions by a second subscriber; and receiving, by the SMF, references to the common data without the definitions of the common data.

### DESCRIPTION OF THE RELATED TECHNOLOGY

Fifth-generation (5G) mobile and wireless networks will provide enhanced mobile broadband communications and are intended to deliver a wider range of services and applications as compared to all prior-generation mobile and wireless networks. Compared to prior generations of mobile and wireless networks, the 5G architecture is service-based, meaning that wherever suitable, architecture elements are defined as network functions that offer their services to other network functions via common framework interfaces. To support this wide range of services and network functions across an ever-growing base of user equipment (UE), 5G networks incorporate the network slicing concept utilized in previous-generation architectures.

Within the scope of the 5G mobile and wireless network architecture, a network slice comprises a set of defined features and functionalities that together form a complete Public Land Mobile Network (PLMN) for providing services to UEs. This network slicing permits the controlled composition of a PLMN with the specific network functions and provided services that are required for a specific usage scenario. In other words, network slicing enables a 5G network operator to deploy multiple, independent PLMNs where each is customized by instantiating only those features, capabilities, and services required to satisfy a given subset of the UEs or a related business customer needs.

In particular, network slicing is expected to play a critical role in 5G networks because of the multitude of use cases and new services 5G is capable of supporting. Network service provisioning through network slices is typically initiated when an enterprise requests network slices when registering with an Access and Mobility Management Function (AMF)/Mobility Management Entity (MME) for a 5G network. At the time of registration, the enterprise will typically ask the AMF/MME for characteristics of network slices, such as slice bandwidth, slice latency, processing power, and slice resiliency associated with the network slices. These network slice characteristics can be used in ensuring that assigned network slices are capable of actually provisioning specific services, e.g., based on the requirements of the services, to the enterprise.

### BRIEF DESCRIPTION OF THE DRAWINGS

Details of one or more aspects of the subject matter described in this disclosure are outlined in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

To describe how the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 depicts an exemplary schematic representation of a 5G network environment in which network slicing has been implemented, and in which one or more aspects of the present disclosure may operate according to some embodiments of the present technology;

FIG. 2 is an example network diagram including an N7 interface according to some embodiments of the present technology;

FIG. 3 is an example method for reducing N7 interface traffic and reducing the memory footprint or storage of SMF according to some embodiments of the present technology;

FIG. 4A illustrates an example sequence diagram for reducing N7 interface traffic and reducing the memory footprint or storage of SMF according to some embodiments of the present technology;

FIG. 4B is a continuation of the example sequence diagram for reducing N7 interface traffic and reducing the memory footprint or storage of SMF of FIG. 4A according to some embodiments of the present technology;

FIG. 5 shows an example computing system for implementing certain aspects of the present technology; and

FIG. 6 illustrates an exemplary network device suitable for implementing the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative and is not intended to further limit the scope and meaning of the disclosure or any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for the convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be outlined in the description which follows, and in part will be obvious from the description, or can be learned by practice of the herein disclosed principles. The features and advantages of the disclosure can be realized and obtained using the instruments and combinations particularly pointed out in the appended claims. These and other features of the disclosure will become more fully apparent from the following description and appended claims, or can be learned by the practice of the principles set forth herein.

### Overview

Disclosed are systems, apparatuses, methods, and non-transitory computer-readable medium for reducing interface traffic and memory or storage of session management function. In at least one example, the interface traffic is N7 interface traffic. The examples given herein relate to N7 interface, but other embodiments are possible.

In one aspect, a method may include establishing an exchange of preservation between a session management function (SMF) and a policy control function (PCF) via an interface for a first session by a first subscriber in a wireless network. The method may also include receiving, by the SMF from the PCF, the preservation including definitions of common data and a preserve indication for the definitions of the common data. The definitions of the common data may be used for a plurality of sessions following the first session by a plurality of subscribers. The method may also include storing, by the SMF, the definitions of common data; establishing an exchange of preservation between the SMF and the PCF for one of the plurality of sessions by a second subscriber; and receiving, by the SMF, references to the common data without the definitions of the common data.

In another aspect, a non-transitory computer-readable storage medium having stored therein instructions which, when executed by a processor, cause the processor to establish an exchange of preservation between the SMF and PCF via the interface for a first session by a first subscriber in a wireless network. The instructions may cause the processor to receive, by the SMF from the PCF, the preservation including definitions of common data and a preserve indication for the definitions of the common data, wherein the definitions of the common data may be used for a plurality of sessions following the first session by a plurality of subscribers. The instructions may cause the processor to store, by the SMF, the definitions of common data. The instructions may cause the processor to establish an exchange of preservation between the SMF and the PCF for one of the plurality of sessions by a second subscriber. The instructions may cause the processor to receive, by the SMF, references to the common data without the definitions of the common data.

In a further aspect, a network system may include an SMF, a PCF, an interface between the PCF and the SMF, and one or more processors coupled to the SMF, PCF, and interface. The one or more processors are configured to execute instructions to cause the one or more processors to establish an exchange of preservation between the SMF and PCF via the interface for a first session by a first subscriber in a wireless network. The one or more processors may be configured to execute instructions to cause the one or more processors to receive, by the SMF from the PCF, the preservation including definitions of common data and a preserve indication for the definitions of the common data, wherein the definitions of the common data may be used for a plurality of sessions following the first session by a plurality of subscribers. The one or more processors may be configured to execute instructions to cause the one or more processors to store, by the SMF, the definitions of common data. The one or more processors may be configured to execute instructions to cause the one or more processors to establish an exchange of preservation between the SMF and the PCF for one of the plurality of sessions by a second subscriber. The one or more processors may be configured to execute instructions to cause the one or more processors to receive, by the SMF, references to the common data without the definitions of the common data.

### Example Embodiments

In a 5G core network, subscriber Policy and/or Charging is achieved by network functions SMF/PCF/UPF. PCF installs policy and charging control rule (PCC rule) (e.g., PCCrules, including traffic details), and also provides QoS Data (e.g., QoSData) and charging data (e.g., ChargingData) to SMF via an N7 interface while the examples are provided in regards to a 5G network. The present disclosure may apply to other networks. Among information or constructs exchanged between SMF and PCF, many constructs or information such as QoSData and/or ChargingData, are often the same for many subscribers. For example, based on call types and subscriptions of UEs, most IP Multimedia Subsystem (IMS) calls have the same usage of QoSData and or ChargingData for most subscribers. Millions of subscribers may have the same type of IMS/Data/SOS (Safe Our Ship). SOS is a status indicating that a mobile phone is not connected to a network, but the mobile phone may be used to make emergency calls.

Thus, the same QoSData and/or ChargingData are shared millions of times for millions of subscribers over the N7 interface and are stored in the same way on the SMF for millions of subscribers, which leads to extra traffic exchange on the N7 interface and also uses extra memory or storage on the SMF.

The disclosed technology addresses optimizing an N7 interface and also to reduce the memory or storage of the SMF. The present technology introduces a support feature or support (e.g., IDPreservationSupported) between the SMF and the PCF, which is advertised by the SMF toward the PCF while sending a message (e.g., SmPolicyContextData) from the SMF to the PCF for each subscriber. The message (e.g., SmPolicycontextdata) includes the support feature or support (e.g., IDPreservationSupported), which is currently unavailable.

When providing the ChargingData and/or QoSData to SMF, PCF may indicate to preserve the information or constructs on the SMF to allow the SMF to use the information or constructs across many future sessions. For example, for a first session (i.e., session1), PCF installs PCCruleID (e.g., PCCrule1), which includes references to common data (RefQoS, RefCharging), definitions of reference data (e.g., QoSData1, ChargingData1), and an indication of the “Preserve” (e.g., Preserve set as true).

The SMF may store the constructs that are marked as “Preserve” so that the constructs may be referenced in other sessions by many subscribers. The SMF may maintain a global copy of contexts of constructs that are indicated as “Preserve” by PCF. The global copy of contexts may be accessed by each session.

The present technology may reduce the traffic or packet size between the SMF and the PCF by about 50% to 60% over the N7 interface. The present technology may also reduce the memory or storage on SMF by about 50% to 60% for the information or constructs over the N7 interface in PDU sessions.

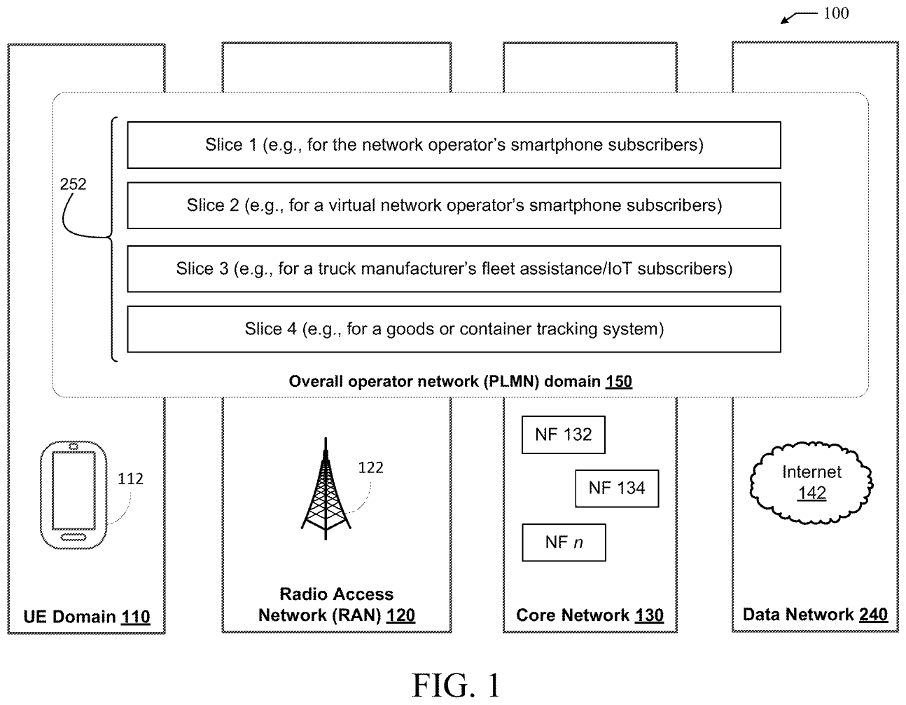

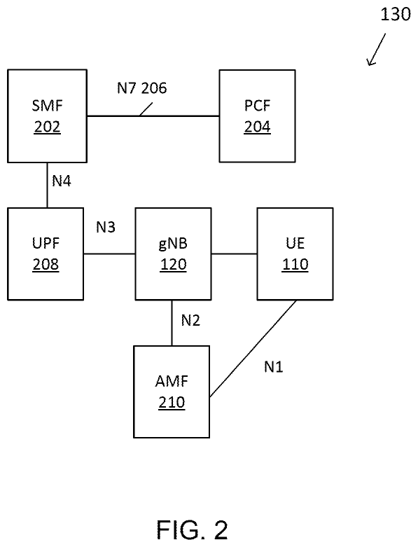

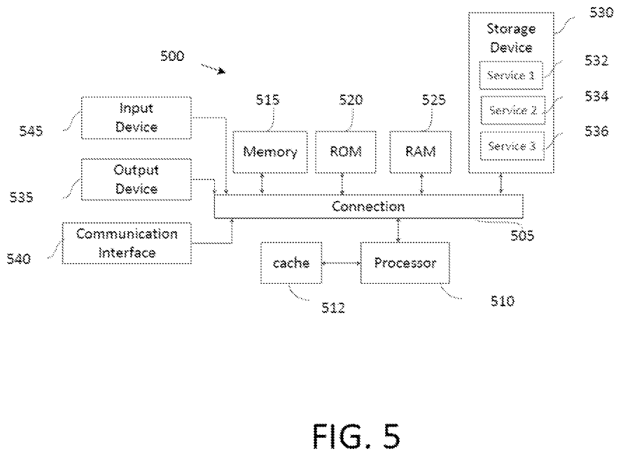

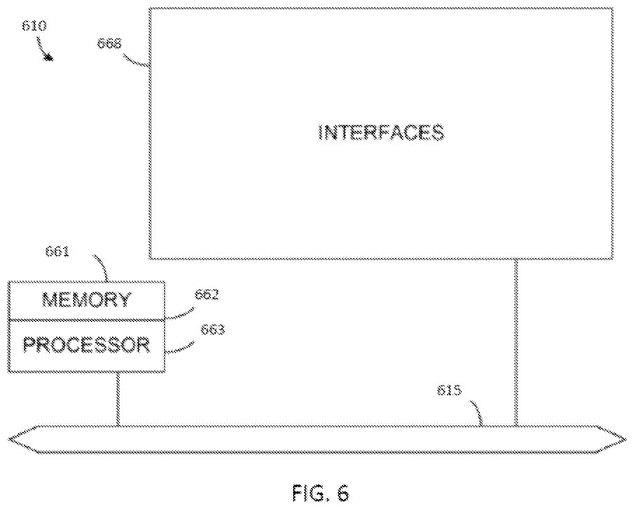

A description of network environments and architectures for network data access and services, as illustrated in FIG. 1 is first disclosed herein. A discussion of systems, methods, and computer-readable medium for network enhancements to reduce N7 interface traffic and also to reduce memory, storage, or session size of the SMF, as shown in FIGS. 2-4, will then follow. The discussion then concludes with a brief description of example devices, as illustrated in FIGS. 5-6. These variations shall be described herein as the various embodiments are set forth. The disclosure now turns to FIG. 1.

FIG. 1 depicts an exemplary schematic representation of a 5G network environment 100 in which network slicing has been implemented, and in which one or more aspects of the present disclosure may operate. As illustrated, network environment 100 is divided into four domains, each of which will be explained in greater depth below; a User Equipment (UE) domain 110, e.g. of one or more enterprises, in which a plurality of user cellphones or other connected devices 112 reside; a Radio Access Network (RAN) domain 120, in which a plurality of radio cells, base stations, towers, or other radio infrastructure 122 resides; a Core Network 130, in which a plurality of Network Functions (NFs) 132, 134, . . . , n reside; and a Data Network 140, in which one or more data communication networks such as the Internet 142 reside. Additionally, the Data Network 140 can support SaaS providers configured to provide SaaSs to enterprises, e.g., to users in the UE domain 110.

Core Network 130 contains a plurality of Network Functions (NFs), shown here as NF 132, NF 134. . . . NF n. In some embodiments, the core network 130 is a 5G core network (5GC) in accordance with one or more accepted 5GC architectures or designs. In some embodiments, the core network 130 is an Evolved Packet Core (EPC) network, which combines aspects of the 5GC with existing 4G networks. Regardless of the particular design of core network 130, the plurality of NFs typically execute in a control plane of the core network 130, providing a service-based architecture in which a given NF allows any other authorized NFs to access its services. For example, a Session Management Function (SMF) controls session establishment, modification, release, etc., and in the course of doing so, provides other NFs with access to these constituent SMF services.

In some embodiments, the plurality of NFs of the core network 130 can include one or more Access and Mobility Management Functions (AMF; typically used when core network 130 is a 5GC network) and Mobility Management Entities (MME; typically used when core network 130 is an EPC network), collectively referred to herein as an AMF/MME for purposes of simplicity and clarity. In some embodiments, an AMF/MME can be common to or otherwise shared by multiple slices of the plurality of network slices 152, and in some embodiments, an AMF/MME can be unique to a single one of the plurality of network slices 152.

The same is true of the remaining NFs of the core network 130, which can be shared amongst one or more network slices or provided as a unique instance specific to a single one of the plurality of network slices 152. In addition to NFs comprising an AMF/MME as discussed above, the plurality of NFs of the core network 130 can additionally include one or more of the following: User Plane Functions (UPFs); Policy Control Functions (PCFs); Authentication Server Functions (AUSFs); Unified Data Management functions (UDMs); Application Functions (AFs); Network Exposure Functions (NEFs); NF Repository Functions (NRFs); and Network Slice Selection Functions (NSSFs). Various other NFs can be provided without departing from the scope of the present disclosure, as would be appreciated by one of ordinary skill in the art.

Across these four domains of the 5G network environment 100, an overall operator network domain 150 is defined. The operator network domain 150 is in some embodiments a Public Land Mobile Network (PLMN) and can be thought of as the carrier or business entity that provides cellular service to the end users in UE domain 110. Within the operator network domain 150, a plurality of network slices 152 are created, defined, or otherwise provisioned to deliver a desired set of defined features and functionalities, e.g. SaaSs, for a certain use case or corresponding to other requirements or specifications. Note that network slicing for the plurality of network slices 152 is implemented in an end-to-end fashion, spanning multiple disparate technical and administrative domains, including management and orchestration planes (not shown). In other words, network slicing is performed from at least the enterprise or subscriber edge at UE domain 110, through the Radio Access Network (RAN) 120, through the 5G access edge and the 5G core network 130, and to the data network 140. Moreover, note that this network slicing may span multiple different 5G providers.

For example, as shown here, the plurality of network slices 152 include Slice 1, which corresponds to smartphone subscribers of the 5G provider who also operates the network domain, and Slice 1, which corresponds to smartphone subscribers of a virtual 5G provider leasing capacity from the actual operator of network domain 150. Also shown is Slice 3, which can be provided for a fleet of connected vehicles, and Slice 4, which can be provided for an IoT goods or container tracking system across a factory network or supply chain. Note that these network slices 152 are provided for purposes of illustration, and in accordance with the present disclosure, and the operator network domain 150 can implement any number of network slices as needed and can implement these network slices for purposes, use cases, or subsets of users and user equipment in addition to those listed above. Specifically, the operator network domain 150 can implement any number of network slices for provisioning SaaSs from SaaS providers to one or more enterprises.

5G mobile and wireless networks will provide enhanced mobile broadband communications and are intended to deliver a wider range of services and applications as compared to all prior-generation mobile and wireless networks. Compared to prior generations of mobile and wireless networks, the 5G architecture is service-based, meaning that wherever suitable, architecture elements are defined as network functions that offer their services to other network functions via common framework interfaces. To support this wide range of services and network functions across an ever-growing base of user equipment (UE), 5G networks incorporate the network slicing concept utilized in previous-generation architectures.

Within the scope of the 5G mobile and wireless network architecture, a network slice comprises a set of defined features and functionalities that together form a complete Public Land Mobile Network (PLMN) for providing services to UEs. This network slicing permits the controlled composition of a PLMN with the specific network functions and provided services that are required for a specific usage scenario. In other words, network slicing enables a 5G network operator to deploy multiple, independent PLMNs where each is customized by instantiating only those features, capabilities, and services required to satisfy a given subset of the UEs or a related business customer needs.

In particular, network slicing is expected to play a critical role in 5G networks because of the multitude of use cases and new services 5G is capable of supporting. Network service provisioning through network slices is typically initiated when an enterprise requests network slices when registering with AMF/MME for a 5G network. At the time of registration, the enterprise will typically ask the AMF/MME for characteristics of network slices, such as slice bandwidth, slice latency, processing power, and slice resiliency associated with the network slices. These network slice characteristics can be used in ensuring that assigned network slices are capable of actually provisioning specific services, e.g. based on the requirements of the services, to the enterprise.

Associating SaaSs and SaaS providers with network slices used to provide the SaaSs to enterprises can facilitate efficient management of SaaS provisioning to the enterprises. Specifically, it is desirable for an enterprise/subscriber to associate already procured SaaSs and SaaS providers with network slices being used to provision the SaaSs to the enterprise. However, associating SaaSs and SaaS providers with network slices is extremely difficult to achieve without federation across enterprises, network service providers, e.g., 5G service providers, and SaaS providers.

FIG. 2 is an example network diagram including an N7 interface according to some embodiments of the present technology. As illustrated in FIG. 2, the core network 130 includes SMF 202 communicating with PCF 204 via interface 206, such as the N7 interface. PCF 204 implements N7 interface 206 to trigger session management policies towards SMF 202. The core network 130 also includes UPF 208 communicates with SMF 202 via an N4 interface. AFM 210 communicates with gNB120 via an N2 interface and communicates with UE 110 via an N1 interface. UE 110 communicates with gNB 120. UPF 208 communicates with gNB 120 via an N3 interface.

In the 5G network, PCF 204 has the following features and functions, including (1) Support 5G QoS policy and charging control functions and the related 5G signaling interfaces. The 3GPP standards, such as N7, N15, N28, N36, and Rx, define these interfaces for the 5G PCF; (2) Provide policy rules for control plane functions, which include network slicing, roaming, and mobility management; (3) Collect the subscriber metrics in context with their network, usage, applications, and more. Operators may analyze this information to optimize resources and make informed decisions to segment users; (4) Provide the real-time management of subscribers, applications, and network resources based on the business rules configured for a service provider; (5) Accelerate and simplify deployment and upgrades, increased speed and efficiency, and low latency by adopting the cloud-native implementation; and (6) Collaborate with other NFs through NRF, which provides a unified communication platform for the NFs to interact with each other.

PCF 204 activates PCC rules for a PDU session in SMF 202, for applications that require detection and report of a start or a stop event to PCF 204. SMF 202 then instructs UPF 208 to detect the event. The PCC rule includes the information that enables the user plane detection of the policy control and the proper charging for a service data flow. Packets detected by applying the service data flow template of the PCC rule form a service data flow.

During session establishment, SMF 202 communicates with PCF 204 over the N7 interface 206. When UE 110 establishes a PDU session, UE 110 requests policies for session management. PCF 204 stores the policies as PCC rules (e.g., PCCrules or PCCruleIDs). When SMF 202 receives the session establishment request from UE 110, SMF 202 requests PCF 204 to provide policies. Then, PCF 204 sends the PCCruleID to SMF 202, which uses the PCCrules to configure the UPF 208 for various data flow tasks, such as shaping, policing to provide bandwidth, and charging functions. Next, PCF 204 sends the PCCruleID to SMF 202. Then, SMF 202 searches the definitions of these PCC rules.

SMF 202 can store the constructs that are marked as “Preserve” so that the constructs can be referenced in other sessions by many subscribers. For example, SMF 202 can maintain a global copy of contexts of constructs that are indicated as “preserve” by PCF 204. The global copy of contexts can be accessed by each session. When the PCC rules are deleted by PCF 204, SMF 202 may delete the global copy of the contexts of constructs when the global copy is not referenced by any other PCC rule.

The present technology can be used for various data, including QoS Data, Charging Data, Usage Monitoring Data, QoS Characteristics, and Traffic Control Data, among other data, on the N7 interface, as long as the constructs for other data have the same contents across subscribers.

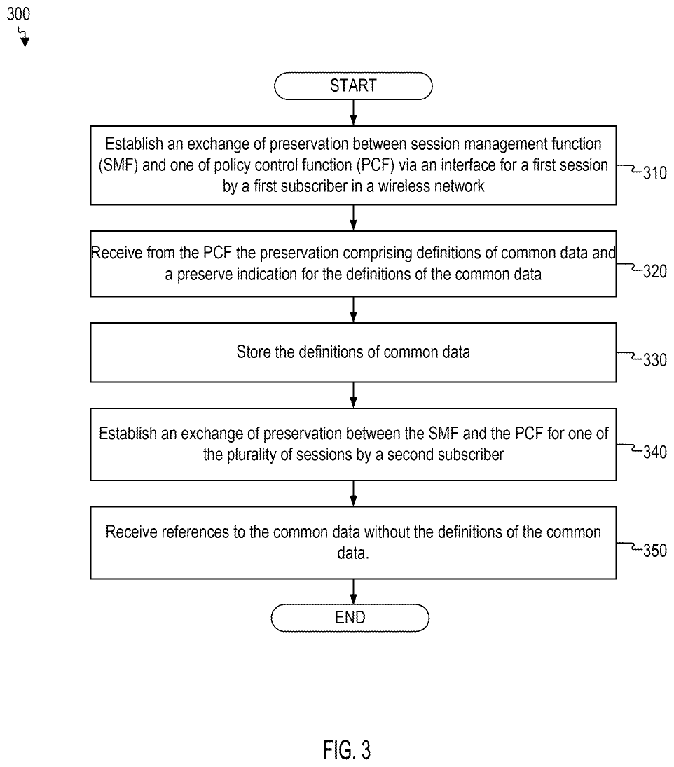

FIG. 3 illustrates an example method 300 for reducing N7 interface traffic and reducing the memory footprint of SMF. Although the example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements method 300 may perform functions at substantially the same time or in a specific sequence.

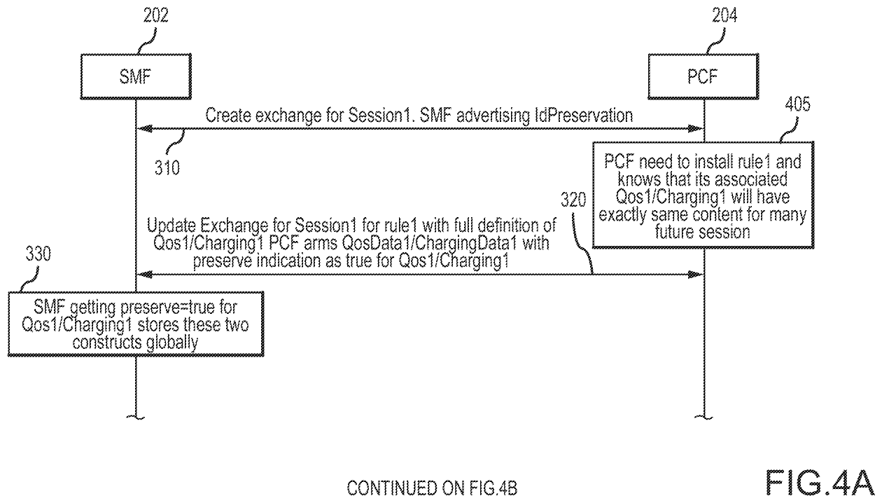

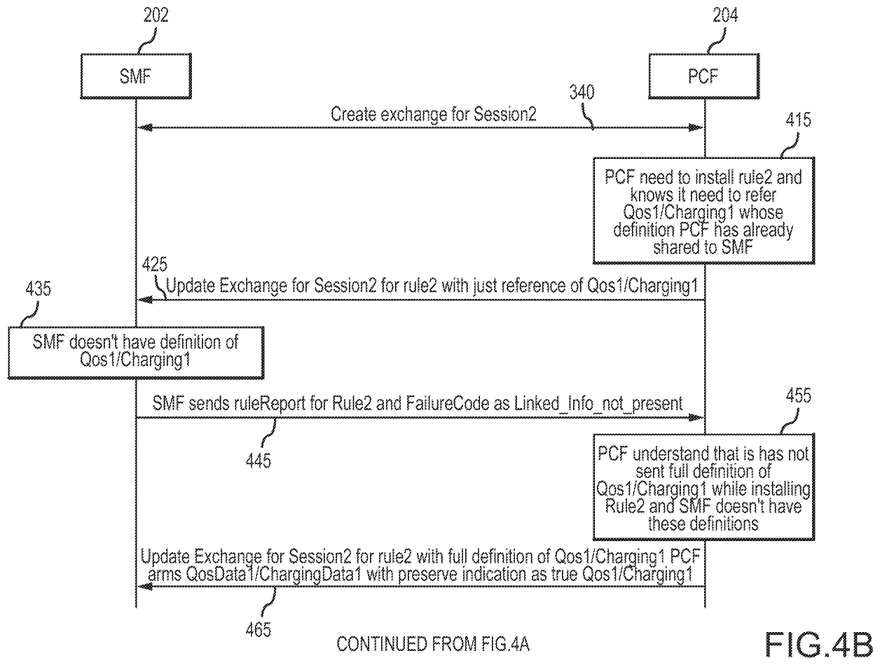

Method 300 illustrated in FIG. 3 will also be discussed in the context of FIGS. 4A-4B, which illustrates a sequence diagram for reducing N7 interface traffic and reducing the memory footprint of SMF. Operations specific to the present technology illustrated in method 300 are present throughout FIGS. 4A-4B, which illustrates an example sequence diagram for reducing N7 interface traffic and reducing the memory footprint of SMF according to some embodiments of the present technology.

According to some examples, method 300 may include establishing an exchange of preservation between the session management function (SMF) and policy control function (PCF) via an interface for a first session by a first subscriber in a wireless network at block 310. For example, the core network 130, as illustrated in FIGS. 1 and 2, may establish an exchange of preservation between SMF 202 and PCF 204 via interface 206 for a first session by a first subscriber in a wireless network. The interface is an N7 interface.

At operation 310 as shown in FIG. 4A, an exchange is created or established for the first session between SMF 202 and PCF 204. SFM advertises iDPresevration. During the setup of a packet data unit (PDU) session, the SMF sends the message (e.g., idPreservationSupported as true) to the PCF. The SMF is capable of storing information or constructs that are common among many PDU sessions even after a first session is deleted or outside the first session in global space to reduce the memory, memory footprint, or storage for each session. When the PCF receives notice of the capability of the support (e.g., idPreservationSupported) from the SMF, the PCF is aware that SMF can reuse the constructs, such as QoSData and/or ChargingData, which have the same contents for many sessions.

In some variations, method 300 may also include installing, by the PCF, a first PCC rule for the first session, wherein the first PCC rule comprises the definitions of common data and the references to the common data, communicating to the SMF via the interface, by the PCF, to update an exchange for the first session with the definitions of the common data, installing, by the PCF, a second PCC rule for a second session, and communicating to the SMF via the interface, by the PCF, to update an exchange for the second session with the references to the common data without the definitions of the common data. The common data may include quality of service (QoS) data and charging data, among others. The second PCC rule is different from the first PCC rule and does not include the definitions of the common data.

At operation 405 as shown in FIG. 4A, the PCF installs PCC Rule 1 for the first session (e.g., session1), which includes definitions of the common data, such as QoS Data1 and charging data1, which may be the same for many future sessions.

According to some examples, method 300 may include receiving by the SMF from the PCF the preservation comprising definitions of common data and a preserve indication for the definitions of the common data at block 320. For example, the SMF 202 as illustrated in FIG. 2 may receive from the PCF 204 the preservation comprising definitions of common data and a preserve indication for the definitions of the common data. The definitions of the common data can be used for a plurality of sessions following the first session by a plurality of subscribers. The preserve indication is also referred to as preservation or indication of “preserve.”

At operation 320, PCF 204 communicates to SMF 202 to update the exchange for the first session for Rule1 with the full definition of QoSData1 and/or ChargingData1. PCF 204 sends or provides definitions of QoSData1 and/ChargingData1 with an indication of “Preserve” (Preserve set as true) for QoSData1/ChargingData1 to the SMF so that the SMF can preserve the contents of the constructs, such as reference QoS data and/or reference charging data. For other sessions using the same ChargingData and/or QoSData, the PCF may send references of the constructs without full definitions of the constructs, such as QoSData1 and/or ChargingData1.

According to some examples, method 300 may include storing by the SMF the definitions of common data at block 330. For example, the SMF 202 as illustrated in FIG. 2 may store the definitions of common data.

At operation 330, SMF 202 gets an indication of “Preserve” (e.g., “Preserve” is set as true) for QoSData1/ChargingData1 from PCF 204 and stores definitions of QoSData1 and ChargingData1 globally.

According to some examples, method 300 may include establishing an exchange of preservation between the SMF and the PCF for one of the plurality of sessions by a second subscriber at block 340. For example, the core network 130, as illustrated in FIGS. 1 and 2, may establish an exchange of preservation between the SMF 202 and the PCF 204 for one of the plurality of sessions by a second subscriber.

For example, there are multiple sessions in time sequence, a first session may start at 12 pm, a second session may start at 12:15 pm, or a third session may start at 12:35 pm, etc.

At operation 415, PCF 204 install PCC Rule 2, which refers to QoSData1 and/or ChargingData1, where the definitions of QoSData1 and/or Charging 1 were shared with SMF in the first session.

For example, for the first session at 12 pm, QoSData1 may be 5 Mbps for the first subscriber. For the second session at 12:15 pm, QoSData2 may be the same as QoSData1 for the second subscriber, and ChargingData2, such as billing, may be the same as ChargingData1 for the second subscriber. For the second session (e.g., session2), PCCrule2 includes RefQoS (e.g., reference to QoSData1), and RefCharging (e.g., reference to ChargingData1). For the second session, the PCF does not send full definitions of QoSData1 and/or ChargingData1 to the SMF, which reduces traffic on the N7 interface. The SMF also stores the common constructs globally rather than storing the constructs for each session, which reduces the memory footprint or storage for the SMF.

At operation 425, PCF 204 communicates to SMF 202 to update an exchange for the second session (e.g., session2) for PCC Rule 2 with references to QoSData1 and/ChargingData1 without full definitions of QoSData1 and/or ChargingData1 or without sending the information of QoSData1 and/or ChargingData1 that are the same as for the first session or session1.

According to some examples, method 300 may include receiving, by the SMF, references to the common data without the definitions of the common data at block 340. For example, the SMF 202 as illustrated in FIG. 2 may receive references to the common data without the definitions of the common data.

In some variations, method 300 may also include sending, by the SMF, a failure message to the PCF, receiving, by the SMF, the definitions of the common data from the PCF, and storing, by the SMF, the definitions of the common data. Operations 435-465 are provided in FIG. 4B as described below.

At operation 435, SMF does not have the definitions of QoS1/Charging1. Then, SMF 202 sends ruleReport for PCCrule 2 and FailureCode as Linked_inofrmation-Not_Present to PCF 204 at operation 445. PCF 204 now understands SMF does not have the definitions of QoS1/Charging1 and installs PCCrule2 at operation 455. Then, PCF communicates to SMF 202 to update an exchange for the second session (e.g., session2) for the second PCC rule (e.g., PCCrule2) with full definitions of QoS1/Charging1 and arms QoS1/Charging1 with an indication of “Preserve” for QoS1/Charging1 at operation 465.

In some variations, the definitions of common data may be stored by the SMF during the first session or may be maintained after the first session or PCCrule1 is deleted.

In some variations, the definitions of common data may be stored by the SMF in a global space to reduce the memory footprint of the SMF.

In some variations, the definitions of the common data are stored and shared among the plurality of subscribers located globally.

In some variations, when SMF loses the contexts of constructs for future sessions, SMF can report failure to PCF by sending a message, such as RuleReport with FailureCode, which indicates that the definition of contents is lost at SMF. PCF can reinstall the PCCrule by providing full contents of reference constructs, such as reference QoS Data or reference Charging Data to SMF.

In some variations, the PCCrule for a session may be deleted by PCF. However, when the PCCrule includes reference data that are marked as “Preserve”, SMF may delete the PCCrule, but the associated QoSData/ChargingData (marked as “Preserve”) with the PCCrule may still be referenced by another PCCrule for a different session. SMF may choose to delete Preserve QoSData/ChargingData when the Preserve Data is not referenced by any PCCrule from any other session.

In some variations, a delta time may be present between the second session and the first session to ensure that the full information from the first session is stored on SMF and that the references can be used for the second session.

FIG. 5 shows an example of computing system 500, which can be for example any computing device making up any of the entities illustrated in FIG. 2, such as SMF or PCF or any component thereof in which the components of the system are in communication with each other using connection 505. Connection 505 can be a physical connection via a bus, or a direct connection into processor 510, such as in a chipset architecture. Connection 505 can also be a virtual, networked connection, or logical connection.

In some embodiments, computing system 500 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Computing system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, close to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, a memory controller, a cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, a keyboard, mouse, motion input, speech, etc. Computing system 500 can also include output device 535, which can be one or more of the output mechanisms known to those of skill in the art. In some instances, multimodal systems can enable a user to provide multiple types of input/output to communicate with computing system 500. Computing system 500 can include a communication interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., and when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in the memory of a client device and/or one or more servers of a content management system and perform one or more functions when a processor executes the software associated with the service. In some embodiments, a service is a program or a collection of programs that carry out a specific function. In some embodiments, a service can be considered a server. Memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special-purpose computer, or special-purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

FIG. 6 illustrates an exemplary network device 610 suitable for implementing the present technology. Network device 610 includes a master central processing unit (CPU) 662, interfaces 668, and bus 615 (e.g., a PCI bus). When acting under the control of appropriate software or firmware, the CPU 662 accomplishes all these functions under the control of software including an operating system and any appropriate applications software. CPU 662 may include one or more processors 663 such as a processor from the Motorola family of microprocessors or the MIPS family of microprocessors. In an alternative embodiment, processor 663 is specially designed hardware for controlling the operations of router 610. In a specific embodiment, a memory 661 (such as non-volatile RAM and/or ROM) also forms part of CPU 662. However, there are many different ways in which memory could be coupled to the system.

Interfaces 668 are typically provided as interface cards (sometimes referred to as “line cards”). Generally, they control the sending and receiving of data packets over the network and sometimes support other peripherals used with the router 610. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, and the like. Generally, these interfaces may include ports appropriate for communication with the appropriate media. In some cases, they may also include an independent processor and, in some instances, volatile RAM. The independent processors may control such communications-intensive tasks as packet switching, media control, and management. By providing separate processors for the communications-intensive tasks, these interfaces allow the master microprocessor 662 to efficiently perform routing computations, network diagnostics, security functions, etc.

Although the system in FIG. 6 is one specific network device of the present technology, it is by no means the only network device architecture on which the present technology can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 661) configured to store program instructions for the general-purpose network operations and mechanisms for roaming, route optimization, and routing functions described herein. The program instructions may control the operation of an operating system and/or one or more applications, for example. The memory or memories may also be configured to store tables such as mobility binding, registration, and association tables, etc.

Aspect 1. A method comprising: establishing an exchange of preservation between the session management function (SMF) and policy control function (PCF) via an interface for a first session by a first subscriber in a wireless network; receiving, by the SMF from the PCF, the preservation comprising definitions of common data and a preserve indication for the definitions of the common data, wherein the definitions of the common data are used for a plurality of sessions following the first session by a plurality of subscribers; storing, by the SMF, the definitions of common data; establishing an exchange of preservation between the SMF and the PCF for one of the plurality of sessions by a second subscriber; and receiving, by the SMF, references to the common data without the definitions of the common data.

Aspect 2. The method of Aspect 1, further comprising: sending, by the SMF, a failure message to the PCF; receiving, by the SMF, the definitions of the common data from the PCF; and storing, by the SMF, the definitions of the common data.

Aspect 3. The method of any of Aspects 1 to 2, wherein the interface is an N7 interface.

Aspect 4. The method of any of Aspects 1 to 3, further comprising: installing, by the PCF, a first PCC rule for the first session, wherein the first PCC rule comprises the definitions of common data and the references to the common data; communicating to the SMF via the interface, by the PCF, to update exchange for the first session with the definitions of the common data; installing, by the PCF, a second PCC rule for a second session; and communicating to the SMF via the interface, by the PCF, to update exchange for the second session with the references to the common data without the definitions of the common data.

Aspect 5. The method of any of Aspects 1 to 4, wherein the common data comprise quality of service (QoS) data and charging data.

Aspect 6. The method of any of Aspects 1 to 5, wherein the second PCC rule is different from the first PCC rule and does not include the definitions of the common data.

Aspect 7. The method of any of Aspects 1 to 6, wherein storing the definitions of common data by the SMF comprises storing the definitions of common data by the SMF during the first session or after the first session is deleted.

Aspect 8. The method of any of Aspects 1 to 7, wherein storing the definitions of common data by the SMF comprises storing the definitions of common data by the SMF in a global space to reduce the memory footprint of SMF.

Aspect 9. The method of any of Aspects 1 to 8, wherein the definitions of the common data are stored and shared among the plurality of subscribers.

Aspect 10. A computer-readable medium comprising instructions using a computer system. The computer includes a memory (e.g., implemented in circuitry) and a processor (or multiple processors) coupled to the memory. The processor (or processors) is configured to execute the computer-readable medium and cause the processor to: establish an exchange of preservation between the session management function (SMF) and policy control function (PCF) via an interface for a first session by a first subscriber in a wireless network; receiving, by the SMF from the PCF, the preservation comprising definitions of common data and a preserve indication for the definitions of the common data, wherein the definitions of the common data are used for a plurality of sessions following the first session by a plurality of subscribers; storing, by the SMF, the definitions of common data; establish an exchange of preservation between the SMF and the PCF for one of the plurality of sessions by a second subscriber; and receiving, by the SMF, references to the common data without the definitions of the common data.

Aspect 11. The computer-readable medium of Aspect 10, wherein sending, by the SMF, a failure message to the PCF; and receiving, by the SMF, the definitions of the common data from the PCF; and storing, by the SMF, the definitions of the common data.

Aspect 12. The computer-readable medium of any of Aspects 10 to 11, wherein the interface is an N7 interface.

Aspect 13. The computer-readable medium of any of Aspects 10 to 12, wherein installing, by the PCF, a first PCC rule for the first session, wherein the first PCC rule comprises the definitions of common data and the references to the common data; communicating to the SMF via the interface, by the PCF, to update exchange for the first session with the definitions of the common data; installing, by the PCF, the first PCC rule for a second session; and communicating to the SMF via the interface, by the PCF, to update exchange for the second session with the references to the common data without the definitions of the common data.

Aspect 14. The computer-readable medium of any of Aspects 10 to 13, wherein the common data comprise quality of service (QoS) data and charging data.

Aspect 15. The computer-readable medium of any of Aspects 10 to 14, wherein the processor is configured to execute the computer-readable medium and cause the processor to: install a second PCC rule for a third session by the PCF by a third subscriber, wherein the second PCC rule is different from the first PCC rule and does not include the definitions of the common data.

Aspect 16. The computer-readable medium of any of Aspects 10 to 15, wherein storing the definitions of common data by the SMF comprises storing the definitions of common data by the SMF during the first session or after the first session is deleted.

Aspect 17. The computer-readable medium of any of Aspects 10 to 16, wherein storing the definitions of common data by the SMF comprises storing the definitions of common data by the SMF in a global space to reduce the memory footprint of the SMF.

Aspect 18. The computer-readable medium of any of Aspects 10 to 17, wherein the definitions of the common data are stored and shared among the plurality of subscribers located globally.

Aspect 19. A network system includes an SMF, a PCF, an interface (e.g., a network interface, a wireless transceiver, etc.) between the PCF and the SMF, and one or more processors coupled to the SMF, PCF, and interface. The one or more processors are configured to execute instructions to cause the one or more processors to: establish an exchange of preservation between the session management function (SMF) and policy control function (PCF) via an interface for a first session by a first subscriber in a wireless network; receive, by the SMF from the PCF, the preservation comprising definitions of common data and a preserve indication for the definitions of the common data, wherein the definitions of the common data are used for a plurality of sessions following the first session by a plurality of subscribers; store, by the SMF, the definitions of common data; establish an exchange of preservation between the SMF and the PCF for one of the plurality of sessions by a second subscriber; and receive, by the SMF, references to the common data without the definitions of the common data.

Aspect 20. The network system of Aspect 19, wherein the one or more processors are configured to execute instructions to cause the one or more processors to send, by the SMF, a failure message to the PCF; and receive, by the SMF, the definitions of the common data from the PCF; and store, by the SMF, the definitions of the common data.

What is claimed is:

1. A method comprising:
establishing an exchange of preservation between a session management function (SMF) and a policy control function (PCF) via an interface for a first session by a first subscriber in a wireless network;
receiving, by the SMF from the PCF, the preservation comprising definitions of common data and a preserve indication for the definitions of the common data, wherein the definitions of the common data are used for a plurality of sessions following the first session by a plurality of subscribers;
storing, by the SMF, the definitions of common data;
establishing an exchange of preservation between the SMF and the PCF for the plurality of sessions by a second subscriber; and
receiving, by the SMF, references to the common data without the definitions of the common data.

2. The method of claim 1, further comprising:
sending, by the SMF, a failure message to the PCF;
receiving, by the SMF, the definitions of the common data from the PCF; and
storing, by the SMF, the definitions of the common data.

3. The method of claim 1, wherein the interface is an N7 interface.

4. The method of claim 1, further comprising:
installing, by the PCF, a first policy and charging control rule (PCC) rule for the first session, wherein the first PCC rule comprises the definitions of common data and the references to the common data;
communicating to the SMF via the interface, by the PCF, to update an exchange for the first session with the definitions of the common data;
installing, by the PCF, a second PCC rule for a second session; and
communicating to the SMF via the interface, by the PCF, to update an exchange for the second session with the references to the common data without the definitions of the common data.

5. The method of claim 4, wherein the common data comprise quality of service (QoS) data and charging data.

6. The method of claim 4, wherein the second PCC rule is different from the first PCC rule and does not include the definitions of the common data.

7. The method of claim 1, wherein storing the definitions of common data by the SMF comprises storing the definitions of common data by the SMF during the first session or after the first session is deleted.

8. The method of claim 1, wherein storing the definitions of common data by the SMF comprises storing the definitions of common data by the SMF in a global space to reduce the memory footprint of the SMF.

9. The method of claim 8, wherein the definitions of the common data are stored and shared among the plurality of subscribers.

10. A non-transitory computer-readable medium comprising instructions, the instructions, when executed by a computing system, cause the computing system to:
establish an exchange of preservation between a session management function (SMF) and a policy control function (PCF) via an interface for a first session by a first subscriber in a wireless network;
receive, by the SMF from the PCF, the preservation comprising definitions of common data and a preserve indication for the definitions of the common data, wherein the definitions of the common data are used for a plurality of sessions following the first session by a plurality of subscribers;
store, by the SMF, the definitions of common data;
establish an exchange of preservation between the SMF and the PCF for one of the plurality of sessions by a second subscriber; and
receive, by the SMF, references to the common data without the definitions of the common data.

11. The computer-readable medium of claim 10, wherein the instructions, when executed by a computing system, cause the computing system to:
send, by the SMF, a failure message to the PCF;
receive, by the SMF, the definitions of the common data from the PCF; and
store, by the SMF, the definitions of the common data.

12. The computer-readable medium of claim 10, the interface is an N7 interface.

13. The computer-readable medium of claim 10, wherein the instructions, when executed by a computing system, cause the computing system to:
install, by the PCF, a first policy and charging control (PCC) rule for the first session, wherein the first PCC rule comprises the definitions of common data and the references to the common data;
communicate to the SMF via the interface, by the PCF, to update an exchange for the first session with the definitions of the common data;
install, by the PCF, the first PCC rule for a second session; and
communicate to the SMF via the interface, by the PCF, to update an exchange for the second session with the references to the common data without the definitions of the common data.

14. The computer-readable medium of claim 13, wherein the common data comprise quality of service (QoS) data and charging data.

15. The computer-readable medium of claim 13, wherein the computer-readable medium further comprises instructions that, when executed by the computing system, cause the computing system to install a second PCC rule for a third session by the PCF by a third subscriber, wherein the second PCC rule is different from the first PCC rule and does not include the definitions of the common data.

16. The computer-readable medium of claim 10, wherein the instructions, when executed by a computing system, cause the computing system to store the definitions of common data by the SMF comprises the instructions, when executed by the computing system, cause the computing system to store the definitions of common data by the SMF during the first session or to maintain after the first session is deleted.

17. The computer-readable medium of claim 10, wherein the instructions, when executed by a computing system, cause the computing system to store the definitions of common data by the SMF comprises the instructions, when executed by the computing system, cause the computing system to store the definitions of common data by the SMF in a global space to reduce the memory footprint of the SMF.

18. The computer-readable medium of claim 17, the definitions of the common data are stored and shared among the plurality of subscribers located globally.

19. A network system comprising:
a session management function (SMF);
a policy control function (PCF);
an interface between the PCF and the SMF; and
one or more processors coupled to the SMF, PCF, and interface, the one or more processors configured to execute instructions to cause the one or more processors to:
establish an exchange of preservation between the SMF and PCF via the interface for a first session by a first subscriber in a wireless network;
receive, by the SMF from the PCF, the preservation comprising definitions of common data and a preserve indication for the definitions of the common data, wherein the definitions of the common data are used for a plurality of sessions following the first session by a plurality of subscribers;
store, by the SMF, the definitions of common data;
establish an exchange of preservation between the SMF and the PCF for one of the plurality of sessions by a second subscriber; and
receive, by the SMF, references to the common data without the definitions of the common data.

20. The network system of claim 19, wherein the one or more processors are configured to execute instructions to cause the processor to:
send, by the SMF, a failure message to the PCF;
receive, by the SMF, the definitions of the common data from the PCF; and
store, by the SMF, the definitions of the common data.
